(19) United States
(12) Patent Application Publication
(10) Pub. No.: US 2026/0087531 A1
(43) Pub. Date: Mar. 26, 2026

(54) PREDICTION SYSTEM FOR PRICE OF RAW AND FRESH MILK BASED ON LARGE DATA

(71) Applicant: Hebei Province animal Husbandry superior breed work main station (Hebei province zhong livestock &, Shijiazhuang (CN)

(72) Inventors: Zhuoran Ma, Shijiazhuang (CN); Yabin Ma, Shijiazhuang (CN); Liyun Zhu, Shijiazhuang (CN); Huiqiu Zhao, Shijiazhuang (CN); Yu Deng, Shijiazhuang (CN)

(21) Appl. No.: 18/923,079

(22) Filed: Oct. 22, 2024

(30) Foreign Application Priority Data
Sep. 25, 2024 (CN) 202411104126.3

(51) Int. Cl. G06Q 30/0283

(52) U.S. Cl. CPC G06Q 30/0283

(57) ABSTRACT

Disclosed is a prediction system for a price of raw and fresh milk based on large data, including: collecting and preprocessing original market data to obtain market data; implementing an adaptive clustering algorithm on the market data; constructing a game theory model and introducing Nash equilibrium analysis of mixed strategies to calculate an optimal strategy combination of each market stage; predicting a price of raw and fresh milk using the optimal strategy combination; and modifying the game theory model, predicting the price of raw and fresh milk using the modified game theory model, and visually displaying a prediction result. In the present disclosure, the problems of a fixed algorithm structure mostly adopted in the existing clustering algorithms and lack of a dynamic adjustment mechanism are solved.

### CROSS-REFERENCE TO RELATED APPLICATION

This application claims priority of Chinese Patent Application No. 202411104126.3, filed on Sep. 25, 2024, the entire contents of which are incorporated herein by reference.

### TECHNICAL FIELD

The present disclosure relates to the field of agricultural economy, and in particular to a prediction system for a price of raw and fresh milk based on large data.

### BACKGROUND

The raw and fresh milk market data has the characteristics of large scale, multi-dimensionality, high timeliness and complex relevance, posing a serious technical challenge for data processing and analysis. At present, raw and fresh milk market data processing and analysis mainly rely on traditional data processing methods and machine learning algorithms. These methods include time series analysis, regression analysis and various clustering algorithms. These technologies perform data classification, pattern recognition and trend analysis by processing and analyzing historical market data and constructing data models. However, these methods still have technical limitations when dealing with large-scale and complex raw and fresh milk market data.

The prior art faces the following technical challenges in the processing and analysis of raw and fresh milk market data. Most of the existing clustering algorithms adopt a fixed algorithm structure, lacking a dynamic adjustment mechanism, which leads to the inability to effectively adapt to the change of data distribution when dealing with variable market data, affecting the efficiency and accuracy of data processing. Especially, when different market stages need to be divided and complex market states need to be identified, it is difficult for the fixed algorithm structure to accurately capture dynamic changes of the market; and traditional market analysis models often ignore the complex interactive relationship among market participants. The raw and fresh milk market involves many participants, such as producers, wholesalers, retailers and consumers, and there is a complex game relationship among them. It is difficult for the existing analysis methods to comprehensively consider these factors, leading to the limited prediction accuracy of the model. The existing price prediction methods are mainly based on a linear model, and it is difficult to accurately capture nonlinear fluctuation characteristics of a market price of raw and fresh milk; and the linear prediction model often shows large prediction bias when dealing with such complex price data. Therefore, there is an urgent need to develop a new technical solution to solve the above-mentioned problems.

### SUMMARY

The present disclosure provides a prediction system for a price of raw and fresh milk based on large data to solve the following problems. Most of the existing clustering algorithms adopt a fixed algorithm structure, lacking a dynamic adjustment mechanism, which leads to the inability to effectively adapt to the change of data distribution when dealing with variable market data, affecting the efficiency and accuracy of data processing. Especially, when different market stages need to be divided and complex market states need to be identified, it is difficult for the fixed algorithm structure to accurately capture the dynamic changes of the market; and traditional market analysis models often ignore the complex interactive relationship among market participants. The raw and fresh milk market involves many participants, such as producers, wholesalers, retailers and consumers, and there is a complex game relationship among them. It is difficult for the existing analysis methods to comprehensively consider these factors, leading to the limited prediction accuracy of the model. The existing price prediction methods are mainly based on a linear model, and it is difficult to accurately capture nonlinear fluctuation characteristics of a market price of raw and fresh milk; and the linear prediction model often shows large prediction bias when dealing with such complex price data.

The present disclosure provides a prediction system for a price of raw and fresh milk based on large data, specifically including the following technical solutions:

A prediction system for a price of raw and fresh milk based on large data includes: a data collection module, configured to collect original market data; a data processing module, configured to preprocess the original market data to obtain market data; a data analysis module, configured to implement an adaptive clustering algorithm on the market data to dynamically adjust a market state; a game theory modeling module, configured to construct a game theory model, and introduce Nash equilibrium analysis of mixed strategies to calculate an optimal strategy combination; a price prediction module, configured to predict a price of raw and fresh milk using the optimal strategy combination, modify the game theory model, and predict a price of raw and fresh milk again using the modified game theory model to obtain a prediction result; and a display module, configured to visually display the prediction result. The data collection module is connected to the data processing module through data transmission, the data processing module is connected to the data analysis module through data transmission, the data analysis module is connected to the game theory modeling module through data transmission, the game theory modeling module is connected to the price prediction module through data transmission, and the price prediction module is connected to the display module through data transmission.

Preferably, the adaptive clustering algorithm in the data analysis module divides the market data into two or more stages, and each stage represents a different market state and a price fluctuation pattern, the market state being represented by the number of clusters and a cluster center, and the price fluctuation pattern being represented by an intra-cluster variance and an inter-cluster variance.

Preferably, an implementation process of the adaptive clustering algorithm includes: step one, setting an initial number of clusters and an initial cluster center; step two, dynamically adjusting the cluster center; step three, calculating the intra-cluster variance and the inter-cluster variance; and step four, dynamically adjusting the number of clusters by comparing a ratio of the intra-cluster variance to the inter-cluster variance.

Preferably, a process of the dynamically adjusting the cluster center includes calculating and updating a cluster center of each of clusters according to data points belonging to each of the clusters in a current iteration; and optimizing an adaptive clustering result through the number of clusters and the cluster centers after dynamical adjustment.

Preferably, the game theory module constructed by the game theory modeling module includes defining a revenue function of producers.

Preferably, the Nash equilibrium analysis of mixed strategies introduced by the game theory modeling module includes calculating an optimal mixed strategy of the producers, the optimal mixed strategy being based on the revenue function of the producers and a strategy combination of other participants; and determining the optimal mixed strategy selection of the participants based on the optimal mixed strategy, to obtain the optimal strategy combination of each market stage.

Preferably, a process of predicting, by the price prediction module, a price of raw and fresh milk using the optimal strategy combination includes considering a wholesale price, a retail price, the market demand quantity and market benchmark demand quantity.

Preferably, a process of modifying, by the price prediction module, the game theory model includes verifying a predicted price of raw and fresh milk using historical market data and optimizing the game theory model by adjusting fitting parameters.

### A Prediction Method for a Price of Raw and Fresh Milk Based on Large Data Includes the Steps of:

S1: preprocessing the collected original market data to obtain market data; and implementing an adaptive clustering algorithm on the market data to dynamically adjust a market state;
S2: constructing a game theory model, and introducing Nash equilibrium analysis of mixed strategies to calculate an optimal strategy combination;
S3: using the optimal strategy combination to predict a price of raw and fresh milk;
S4: modifying the game theory model, and using the modified game theory model to predict the price of raw and fresh milk to obtain a prediction result; and
S5: visually displaying the prediction result.

### Preferably, S2 Specifically Includes:

calculating, through the Nash equilibrium analysis of mixed strategies, an optimal mixed strategy of participants under different combinations of strategies; and determining, based on the optimal mixed strategy, the optimal mixed strategy selection of the participants to obtain the optimal strategy combination.

The technical solutions of the present disclosure have the following advantageous effects.
1. The adaptive clustering algorithm improves the capacity of processing market data. By dynamically adjusting the number of clusters and cluster centers, the algorithm can more accurately identify and characterize different market states, provide a more reliable technical basis for subsequent data analysis, and improve the data processing efficiency and accuracy of the prediction system for a price of raw and fresh milk.
2. Through the game theory model, the prediction system for a price of raw and fresh milk can more comprehensively process and analyze complex interaction data among market participants. The introduction of Nash equilibrium analysis of mixed strategies further enhances the data processing capability of the game theory model, and improves the reliability of data analysis, and the simulation accuracy of the prediction system for a price of raw and fresh milk on complex market behaviors.
3. A nonlinear term is introduced to enhance the ability of the prediction system for a price of raw and fresh milk to process nonlinear price data, so that the system can more accurately simulate and predict complex price fluctuations, and improve the accuracy of prediction and the reliability of data analysis.
4. By introducing the historical market data to verify and modify the game theory model, the accuracy and reliability of a prediction model are significantly improved. This technical means enables the prediction system for a price of raw and fresh milk to continuously optimize the prediction model according to actual market data, and improve the reliability of data analysis, thus improving the adaptability and prediction accuracy of the prediction system for a price of raw and fresh milk.

### BRIEF DESCRIPTION OF THE DRAWINGS

FIG. 1 is a structural diagram of a prediction system for a price of raw and fresh milk based on large data according to the present disclosure; and

FIG. 2 is a flow chart of a prediction method for a price of raw and fresh milk based on large data according to the present disclosure.

### DETAILED DESCRIPTION

In order to further explain the technical means and effects adopted by the present disclosure to achieve a predetermined purpose, the technical solutions in examples of the present disclosure are described clearly and completely with the attached drawings of the examples of the present disclosure. Obviously, all the described examples are only some, rather than all examples of the present disclosure. Based on the examples in the present disclosure, all other examples obtained by those of ordinary skill in the art without creative efforts belong to the scope of protection of the present disclosure.

Unless otherwise defined, all technical and scientific terms used herein have the same meaning as commonly understood by those skilled in the art of the present disclosure.

The specific solutions of a prediction system for a price of raw and fresh milk based on large data provided by the present disclosure are explained in detail with the attached drawings.

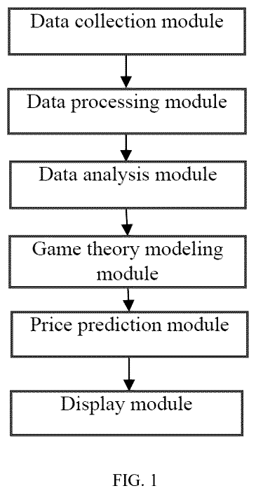

Referring to FIG. 1, a structural diagram of a prediction system for a price of raw and fresh milk based on large data according to an example of the present disclosure is as shown. The system includes the following parts:
a data collection module, a data processing module, a data analysis module, a game theory modeling module, a price prediction module and a display module.

The data collection module is configured to collect original market data from dairy production enterprises, wholesale markets, retailers and e-commerce platforms for subsequent processing; and the data collection module is connected to the data processing module through data transmission.

The data processing module is configured to perform preprocessing, such as data cleansing and data normalization, on the original market data from the data collection module, and output market data; and the data processing module is connected to the data analysis module through data transmission.

The data analysis module is configured to implement an adaptive clustering algorithm on the market data, and divide the market data into multiple stages, each stage representing a different market state and a price fluctuation pattern; the market state being represented by the number of clusters and cluster centers, and the price fluctuation pattern being represented by an intra-cluster variance and an inter-cluster variance. Specifically, the number of clusters and the cluster centers are dynamically adjusted according to the distribution of data points in the market data, and a market stage is divided using the number of clusters and the cluster center of each of the clusters after dynamical adjustment.

An implementation process of the adaptive clustering algorithm includes: step one, setting an initial number of clusters and an initial cluster center; step two, dynamically adjusting the cluster center; step three, calculating the intra-cluster variance and the inter-cluster variance; and step four, dynamically adjusting the number of clusters by comparing a ratio of the intra-cluster variance to the inter-cluster variance. A process of the dynamically adjusting the cluster center includes calculating and updating a cluster center of each of clusters according to data points belonging to each of the clusters in a current iteration; and optimizing an adaptive clustering result through the number of clusters and the cluster centers after dynamical adjustment. The data analysis module is connected to the game theory modeling module through data transmission.

The game theory modeling module is configured to perform game modeling on producers, wholesalers, retailers and consumers in each market stage, and define a revenue function of the producers. The revenue function considers the wholesale price, production quantity and production cost. An optimal mixed strategy in each market stage is calculated using the Nash equilibrium analysis of mixed strategies, the optimal mixed strategy is based on the revenue function of the producers and a strategy combination of other participants; and based on the optimal mixed strategy, the optimal mixed strategy selection of the participants in the market stage is determined by the distribution of mixed strategy probability of each of the participants. The game theory modeling module is connected to the price prediction module through data transmission.

The price prediction module is configured to perform price prediction according to an optimal strategy combination to obtain a predicted price of raw and fresh milk. A formula is as follows:

$${P}_{future} = \frac{1}{N} {\sum }_{θ = 1}^{N} ( {θ}_{} \cdot exp ( \frac{ln ( {θ}_{} ) - ln ( {θ}_{} + ϵ )}{1 + {e}^{- v ( {Q}_{θ} - {\dot{Q}}_{θ} )}} ) )$$

where P_{future} is a predicted price of raw and fresh milk; N is the number of market stages, a numerical value being a value of the number of clusters in an adaptive clustering algorithm; [symbol] is a wholesale price of participants at a θ^{th} market stage in an optimal strategy combination; [symbol] is a retail price selected by the participants at the θ^{th} market stage in the optimal strategy combination; Q_{θ} is the market demand quantity at the θ^{th} market stage, obtained by time series analysis of historical market demand data from historical market data; ϵ, a constant, is specifically set according to a specific scenario and is used for avoiding a logarithmic zero value; \dot{Q}_{θ} is the market benchmark demand quantity at the θ^{th} market stage; and v is a response velocity of a game theory model; \dot{Q}_{θ} and v being fitting parameters, and specific values being obtained by performing regression analysis on the historical market data, reflecting a basic level and a response velocity of the market demand. The time series analysis and the calculation of fitting parameters are prior art, and will not be described in detail herein. Based on the historical market data, the predicted price of raw and fresh milk is verified, and the game theory model is modified by adjusting the fitting parameters. The price of raw and fresh milk is predicted using the modified game theory model to obtain a prediction result. The price prediction module is connected to the display module through data transmission.

The display module is configured to visually display a prediction result. The prediction result is visually displayed through charts and other means to help users to keep abreast of market dynamics.

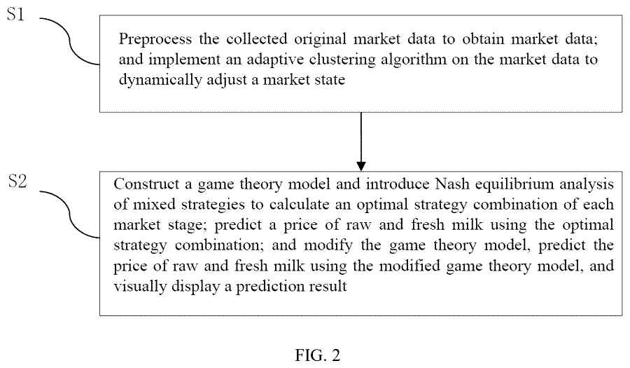

Referring to FIG. 2, a flow chart of a prediction method for a price of raw and fresh milk based on large data according to an example of the present disclosure is as shown. The method includes the following steps.

In S1: the collected original market data is preprocessed to obtain market data; and an adaptive clustering algorithm is implemented on the market data to dynamically adjust a market state and divide market stages.

Original market data of the raw and fresh milk market is collected from dairy production enterprises, wholesale markets, retailers and e-commerce platforms, including prices (producer prices, wholesale prices, and retail prices), trading volumes (daily or weekly sales volumes), and supply and demand information (supply and demand balance data on the market, describing the relationship between supply quantity and demand quantity of raw and fresh milk on the market). Next, the collected original market data is preprocessed to obtain market data; and the preprocessing includes data cleansing and normalization processing, the data cleansing including missing values and abnormal values processing. The above-mentioned preprocessing processes all adopt the prior art and will not be described in detail herein.

After the data preprocessing is completed, the adaptive clustering algorithm is implemented.

The adaptive clustering algorithm divides the market data into multiple stages, and each stage represents a different market state and a price fluctuation pattern. The market state is represented by the number of clusters and cluster centers. The number of clusters, a numerical value, represents the number of market states currently identified and reflects the complexity of the market; and the cluster center, a numerical value, represents a center value of each cluster (market state) and reflects a characteristic mean of the market state, characteristics being prices or trading volumes. The data points in the market data are specific market data values, such as prices (producer prices, wholesale prices and retail prices) and trading volumes at different time points. The number of data points represents the number of data belonging to a certain market state. By dynamically adjusting the number of clusters and cluster centers, the adaptive clustering algorithm constantly optimizes adaptive clustering results according to the distribution of data points in the market data to better reflect the actual situation of the market.

The price fluctuation pattern is represented by an intra-cluster variance and an inter-cluster variance. The intra-cluster variance is a numerical value for measuring the degree of dispersion among data points in the same cluster. The larger the intra-cluster variance, the larger the price and trading volume fluctuation in this market state. The smaller the intra-cluster variance, the more stable the price and trading volume in this market state. The inter-cluster variance is a numerical value for measuring the degree of dispersion between different clusters. The larger the inter-cluster variance, the larger the difference between different market states; and the smaller the inter-cluster variance, the more similar the market states.

The adaptive clustering algorithm process is as follows:

The statistical analysis and distribution analysis are performed on historical market data; and the initial number of clusters Ko and an initial cluster center μ_{k,0} are set based on the expert experience method, and the specific setting method is specifically set according to specific implementation scenarios.

The cluster centers are adjusted dynamically, and a formula is as follows:

$${μ}_{k , t + 1} = exp ( \frac{1}{{n}_{k , t}} {\sum }_{i = 1}^{{n}_{k , t}} ln ( {x}_{i , t} + ε ) )$$

where μ_{k,t+1} is a cluster center of a k^{th} cluster after a t+1^{th} iteration; k is an index of the cluster; n_{k,t} is the number of data points belonging to a k^{th} cluster in a t^{th} iteration; x_{i,t} represents an i^{th} data point in the t^{th} iteration, which is an actual data point value obtained in market data; exp represents an exponential function; ϵ is a constant, specifically set according to a specific scenario, and used for avoiding a logarithmic zero value.

The intra-cluster variance is calculated as follows:

$${σ}_{within , t} = \frac{1}{{K}_{t}} {\sum }_{k = 1}^{{K}_{t}} \sqrt{\frac{1}{{n}_{k , t}} {\sum }_{i = 1}^{{n}_{k , t}} {( ln ( {x}_{i , t} + ϵ ) - ln ( {μ}_{k , t} + ϵ ) )}^{2}}$$

where σ_{within,t} is an intra-cluster variance of a t^{th} iteration and a subscript within represents intra-cluster; Kₜ is the number of clusters in the t^{th} iteration; and μ_{k,t} is a cluster center of a k^{th} cluster after the t^{th} iteration.

The inter-cluster variance is calculated as follows:

$${σ}_{between , t} = \frac{1}{{K}_{t}} {\sum }_{k = 1}^{{K}_{t}} \sqrt{{{n}_{k , t} ( ln ( {μ}_{k , t} + ϵ ) - ln ( {μ}_{all , t} + ϵ ) )}^{2}}$$

$${μ}_{all , t} = exp ( \frac{1}{{N}_{t}} {\sum }_{i = 1}^{{N}_{t}} ln ( {x}_{i , t} + ϵ ) )$$

where σ_{between,t} is an inter-cluster variance of a t^{th} iteration, and a subscript between represents intra-cluster; μ_{all,t} is a mean of all data points in the t^{th} iteration, i.e., a compound average of a whole market, and a subscript all represents all data points; and Nₜ is the number of all data points in the t^{th} iteration.

The adaptive clustering algorithm dynamically adjusts the number of clusters by comparing a ratio of the intra-cluster variance and the inter-cluster variance to better reflect the actual situation of the market and the price fluctuation pattern. The formula is as follows:

$${K}_{t + 1} = \{ \begin{matrix}{K}_{t} + 1 , & if \sqrt{\frac{{σ}_{within , t}}{{σ}_{between , t}}} > α \\ {K}_{t} + 1 , & if \sqrt{\frac{{σ}_{within , t}}{{σ}_{between , t}}} < β \\ {K}_{t} , & otherwise\end{matrix}$$

where Kₜ₊₁ is the number of clusters in a t+1^{th} iteration; and α and β are pre-set threshold values, and are specifically set according to specific implementation scenarios.

The number of clusters and the cluster center of each of the clusters after dynamical adjustment by the adaptive clustering algorithm, namely, adaptive clustering results, reflect different stages of market data, for example: a stage of high demand and low supply is characterized by higher price and larger trading volume, and values of price and trading volume data points in the cluster center are higher than a mean and variance of the overall market data; a stage of supply-demand equilibrium is characterized by relatively stable price and trading volume, values of price and trading volume data points in the cluster center are close to a mean value of the overall market data, and the intra-cluster variance is small, representing that the fluctuation is small; and a stage of low demand and high supply is characterized by lower price and smaller trading volume, and values of price and trading volume data points in the cluster center are significantly lower than a mean and variance of the overall market data. Specific market stage division criteria can be specifically set according to specific scenarios.

In S2, based on the divided market stages, a game theory model is constructed and Nash equilibrium analysis of mixed strategies is introduced to calculate an optimal strategy combination of each market stage; a price of raw and fresh milk is predicted using the optimal strategy combination; and the game theory model is modified, the price of raw and fresh milk is predicted using the modified game theory model, and a prediction result is visually displayed.

Based on the market stages divided according to the adaptive clustering result, participants in each market stage are gamed, and the participants include producers, wholesalers, retailers and consumers. The game theory model is designed to consider the strategy and revenue of participants.

The game theory model can predict the price of raw and fresh milk by simulating the strategy selection and revenue among participants to find the market equilibrium state. The input data of the game theory model includes the strategy combination, cost, price and demand quantity of the participants. The strategy combination is the selection of the production quantity and ex-factory price of producers, the wholesale price and purchase quantity of wholesalers, the retail price and inventory quantity of retailers, and the purchase quantity and purchase channel of consumers. The output data is an optimal strategy combination, including production quantity, wholesale prices and retail prices for participants at different market stages.

The Nash equilibrium analysis of mixed strategies is introduced to make the game theory model more accurately reflect dynamic changes of the market. The Nash equilibrium analysis of mixed strategy is a game theory method, which is used for finding the optimal mixed strategy of participants under different strategy combinations. In the optimal mixed strategy, each participant's strategy selection is optimal, and no participant can obtain higher revenue by unilaterally changing the strategy.

A construction process of the game theory model is as follows:

A revenue function of producers is defined as follows:

$${U}_{j} = ln ( {pw}_{j} {q}_{j} ) - \sqrt{C ( {q}_{j} )}$$

where Uⱼ represents revenue of producers j; pwⱼ is a wholesale price of wholesalers; qⱼ is the production quantity of the producers; C(qⱼ) represents the cost of the production quantity qⱼ.

By using the Nash equilibrium analysis of mixed strategy, the optimal mixed strategy of each market stage is calculated:

$${ζ}_{j}^{*} = arg {max}_{{ζ}_{j}} {\int }_{{S}_{j}} {ζ}_{j} ( s ) ln ( {U}_{j} ( s , {ζ}_{- j}^{*} ) + ϵ ) ds$$

$${U}_{j} ( s , {ζ}_{- j}^{*} ) = ln ( {pw}_{j} {q}_{j} ( s ) ) - \sqrt{C ( {q}_{j} ( s ) )}$$

$$where {ζ}_{j}^{*}$$

is an optimal mixed strategy of producers j; ζⱼ is a mixed strategy of the producers j; ζⱼ(s) is the probability that the producers j select the mixed strategy s; Sⱼ is a set of all possible mixed strategies, which is obtained by using a strategy enumeration algorithm, and will not be described in detail here; Uⱼ(s,

$${ζ}_{- j}^{*} )$$

is a revenue function of the producers j under the mixed strategy s and a strategy combination

$${ζ}_{- j}^{*}$$

of participants except the producers j; qⱼ(s) is the production quantity of the producers under the mixed strategy s; C(qⱼ(s)) is the cost of the production quantity qⱼ(s) of the producers under the mixed strategy s; s is a specific strategy in the mixed strategy set; and

$${ζ}_{- j}^{*}$$

is a strategy combination of participants except the producers j.

After obtaining the optimal mixed strategy of each market stage, the optimal mixed strategy selection of the participants in the market stage is determined through the probability distribution of mixed strategies of the participants to obtain an optimal strategy combination of each market stage, and the price of raw and fresh milk is predicted using the optimal strategy combination. The formula is as follows:

$${P}_{future} = \frac{1}{N} {\sum }_{θ = 1}^{N} ( {θ}_{} \cdot exp ( \frac{ln ( {θ}_{} ) - ln ( {θ}_{} + ϵ )}{1 + {e}^{- v ( {Q}_{θ} - {\dot{Q}}_{θ} )}} ) )$$

where P_{future} is a predicted price of raw and fresh milk; N is the number of market stages, a numerical value being a value of the number of clusters in an adaptive clustering algorithm; [symbol] is a wholesale price of participants at a θ^{th} market stage in an optimal strategy combination; [symbol] is a retail price selected by the participants at the θ^{th} market stage in the optimal strategy combination; Q_{θ} is the market demand quantity at the θ^{th} market stage, obtained by time series analysis of historical market demand data from historical market data; \dot{Q}_{θ} is the market benchmark demand quantity at the θ^{th} market stage; and v is a response velocity of a game theory model; \dot{Q}_{θ} and v being fitting parameters, and specific values being obtained by performing regression analysis according to the historical market data, reflecting a basic level and a response velocity of the market demand. The time series analysis and the calculation of fitting parameters are prior art, and will not be described in detail herein.

The predicted price of raw and fresh milk is verified by the historical market data, which can be acquired from dairy production enterprises, wholesale markets, retailers and e-commerce platforms. The backtesting method is used for verifying the predicted price of raw and fresh milk, and the game theory model is applied to historical data to compare the differences between the prediction result and the actual data. The backtesting method is a prior art, and will not be described in detail herein. By adjusting the fitting parameters, the game theory model can better adapt to the market data, the accuracy and reliability of the game theory model are improved, and the modified game theory model is ultimately obtained.

Finally, the modified game theory model is used for predicting the price of raw and fresh milk, and the prediction result is visually displayed through charts and other means to help users to keep abreast of market dynamics.

In view of the above, the prediction system for a price of raw and fresh milk based on large data is completed.

The order of the examples of the present disclosure is merely illustrative and does not represent the advantages or disadvantages of the examples. The processes depicted in the figures do not necessarily require a particular order shown, or sequential order, to achieve desired results. Multi-tasking and parallel processing are also possible or may be advantageous in some examples.

Various examples described in this specification are described in a progressive manner, and only the same or similar parts between the examples need to be referred to each other, and each example focuses on the differences from other examples.

The above-mentioned examples are only used to illustrate the technical solutions of the present disclosure, but not to limit this. Although the present disclosure has been described in detail with reference to the foregoing examples, those skilled in the art are to be understand that it is still possible to modify the technical solutions described in the foregoing examples, or to replace some technical features with equivalents. However, these modifications or substitutions do not make the essence of the corresponding technical solutions deviate from the spirit and scope of the technical solutions of various examples of the present disclosure, and are included in the protection scope of the present disclosure.

1. A prediction system for a price of raw and fresh milk based on large data, comprising:
one or more processors; a memory storing instructions, executable by the one or more processors, the instructions, when executed by the one or more processors, configuring the one or more processors to:
collect original market data;
preprocess the original market data to obtain market data;
implement an adaptive clustering algorithm on the market data to dynamically adjust a plurality of market states;
construct a game theory model, and introduce Nash equilibrium analysis of mixed strategies to calculate an optimal strategy combination;
predict a price of raw and fresh milk using the optimal strategy combination, modify the game theory model, and predict a price of raw and fresh milk again using the modified game theory model to obtain a prediction result;
instruct a display device to visually display the prediction result, and send the prediction result to producers, wholesalers and retailers for formulating production and operation strategies;
wherein the one or more processors are connected to the display device through data transmission;
wherein the adaptive clustering algorithm divides the market data into at least two market stages, and each market stage comprises a different market state and a price fluctuation pattern; the plurality of market states are represented by number of clusters and a plurality of cluster centers, the price fluctuation pattern is represented by an intra-cluster variance and an inter-cluster variance; the number of clusters represents number of the plurality of market states, and one of the plurality of cluster centers reflects a characteristic mean of one of the plurality of market states;
wherein the game theory model comprises defining a revenue function of producers;
wherein the Nash equilibrium analysis of mixed strategies comprises calculating an optimal mixed strategy of the producers, the optimal mixed strategy being based on the revenue function of the producers and a strategy combination of the wholesalers, the retailers and consumers; and determining the optimal mixed strategy selection of the producers, the wholesalers and the retailers based on the optimal mixed strategy, to obtain the optimal strategy combination of each market stage.

2. (canceled)

3. The prediction system for a price of raw and fresh milk based on large data according to claim 1, wherein an implementation process of the adaptive clustering algorithm comprises: step one, setting an initial number of clusters and an initial cluster center; step two, dynamically adjusting the cluster center; step three, calculating the intra-cluster variance and the inter-cluster variance; and step four, dynamically adjusting the number of clusters by comparing a ratio of the intra-cluster variance to the inter-cluster variance.

4. The prediction system for a price of raw and fresh milk based on large data according to claim 3, wherein a process of the dynamically adjusting the cluster center comprises calculating and updating a cluster center of each of clusters according to data points belonging to each of the clusters in a current iteration; and optimizing an adaptive clustering result through the number of clusters and the cluster centers after dynamical adjustment.

5. (canceled)

6. (canceled)

7. The prediction system for a price of raw and fresh milk based on large data according to claim 1, wherein a process of predicting a price of raw and fresh milk using the optimal strategy combination comprises considering a wholesale price, a retail price, the market demand quantity and market benchmark demand quantity.

8. The prediction system for a price of raw and fresh milk based on large data according to claim 1, wherein a process of modifying the game theory model comprises verifying a predicted price of raw and fresh milk using historical market data and optimizing the game theory model by adjusting fitting parameters.

9. A prediction method for a price of raw and fresh milk based on large data, comprising the following steps performed using the prediction system for a price of raw and fresh milk based on large data according to claim 1:
S1: preprocessing collected original market data to obtain market data; and
implementing an adaptive clustering algorithm on the market data to dynamically adjust a plurality of market states;
S2: constructing a game theory model, and introducing Nash equilibrium analysis of mixed strategies to calculate an optimal strategy combination;
S3: using the optimal strategy combination to predict a price of raw and fresh milk;
S4: modifying the game theory model, and using the modified game theory model to predict the price of raw and fresh milk to obtain a prediction result; and
S5: visually displaying the prediction result; and
S6: sending the prediction result to producers, wholesalers and retailers for formulating production and operation strategies.

10. The prediction method for a price of raw and fresh milk based on large data according to claim 9, wherein S2 specifically comprises:
calculating, through the Nash equilibrium analysis of mixed strategies, an optimal mixed strategy of the producers, the wholesalers and the retailers under different combinations of strategies; and determining, based on the optimal mixed strategy, the optimal mixed strategy selection of the producers, the wholesalers and the retailers to obtain the optimal strategy combination.
